(19) United States
(12) Patent Application Publication
(10) Pub. No.: US 2013/0042761 A1
(43) Pub. Date: Feb. 21, 2013

(54) AIR / CUTTINGS SEPARATOR

(71) Applicant: Mitchell L. Ring, SR., Waynesburg, PA (US)

(72) Inventor: Mitchell L. Ring, SR., Waynesburg, PA (US)

(73) Assignee: BAKER HUGHES INCORPORATED, HOUSTON, TX (US)

(21) Appl. No.: 13/211,926

(22) Filed: Aug. 17, 2011

(51) Int. Cl. B01D 45/12; B04C 5/08; B04C 5/04

(52) U.S. Cl. 95/271; 55/459.1; 55/435

(57) ABSTRACT

An apparatus for separating a return material generated while drilling a borehole into a gas stream and a non-gas stream includes a chamber having an open upper end and an open lower end and a cap. The chamber may be oriented to allow gravity to pull the non-gas stream through the lower end. An inlet associated with the chamber may be oriented to flow the return material into the chamber at a substantially tangential angle. The cap partially encloses the upper end and includes a vent for venting the gas stream.

### CROSS-REFERENCE TO RELATED APPLICATIONS

None.

### 1. FIELD OF THE DISCLOSURE

This disclosure is directed to methods of separating materials recovered from air drilling operations.

### 2. BACKGROUND OF THE DISCLOSURE

This disclosure generally relates to a separation system and more particularly to a separation system for separating the exhaust mixture created during the drilling of a wellbore.

Wellbores are commonly drilled using one of several types of drilling fluids. In some situations, air, gas, or mist may be used as the drilling fluid. For instance, air is circulated down the drill string, out the drill bit and up the annulus between the drill string and the wellbore. The air is typically circulated utilizing large air compressors. The exhaust mixture from the wellbore will typically comprise the air or mist used to drill the well, solid drill cuttings from the wellbore, and any natural gas, water or other fluid encountered during the drilling operation. The air and the drill cuttings are carried up the annulus and are generally blasted out through an exhaust line, typically called a “blooie line,” which is a pipe.

Generally, it is desirable to separate the liquids and solids from the gaseous drilling fluid to facilitate disposal. The present disclosure addresses the need to more efficiently separate liquids and/or solids from drilling gases.

### SUMMARY OF THE DISCLOSURE

In aspects, the present disclosure provides an apparatus for separating a return material generated while drilling a borehole into a gas stream and a non-gas stream. The apparatus may include a chamber having an open upper end and an open lower end. The chamber may be oriented to allow gravity to pull the non-gas stream through the lower end. An inlet associated with the chamber may be oriented to flow the return material into the chamber at a substantially tangential angle. The apparatus may include a cap partially enclosing the upper end and including a vent for venting the gas stream.

In aspects, the present disclosure provides a method for separating a return material generated while drilling a borehole into a gas stream and a non-gas stream. The method may include flowing the return material at a tangent into a chamber having an open upper end and an open lower end, the chamber being oriented to allow gravity to pull the non-gas stream through the lower end. The method further includes flowing the gas stream to the open upper end; directing the gas stream to a vent using a cap partially enclosing the upper end; and flowing the non-gas stream to the open lower end using primarily gravity.

Examples of certain features of the disclosure have been summarized (albeit rather broadly) in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE FIGURES

For detailed understanding of the present disclosure, reference should be made to the following detailed description of the preferred embodiment, taken in conjunction with the accompanying drawing:

FIG. 1 illustrates a drill rig that may use a separator vessel according to one embodiment of the present disclosure;

FIG. 2 schematically illustrates a separator chamber for a separator vessel in accordance with one embodiment of the present disclosure;

FIG. 3 illustrates the tangential angle of an inlet to the separator chamber according to one embodiment of the present disclosure;

FIG. 4 sectionally illustrates one embodiment of the separator vessel according to embodiments of the present disclosure; and

FIG. 5 illustrates a stand for use with a separator vessel according to one embodiment of the present disclosure.

### DETAILED DESCRIPTION OF THE DISCLOSURE

The present disclosure related to methods, systems and devices for efficiently processing gas/liquids/solids recovered during air drilling. The present disclosure is susceptible to embodiments of different forms. The drawings show and the written specification describes specific embodiments of the present disclosure with the understanding that the present disclosure is to be considered an exemplification of the principles of the disclosure, and is not intended to limit the disclosure to that illustrated and described herein.

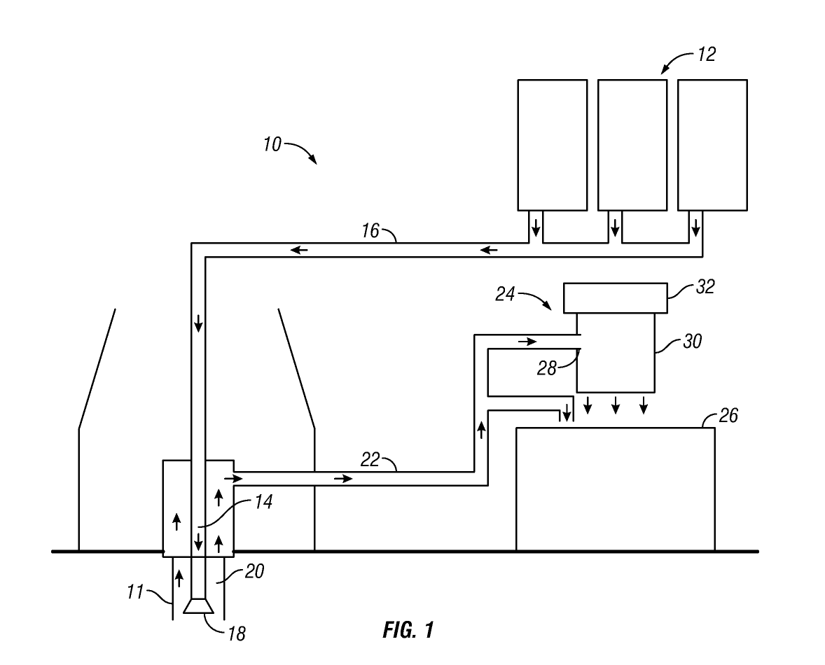

Referring now to FIG. 1, there is shown a drilling rig 10 adapted to drill a borehole 11 in an earthen formation. The rig 10 may include a source 12 for high-pressure gas (e.g., air compressors, boosters, etc.) and a drill string 14 that receives the gas via a line 16. The drill string 14 may include a drill bit 18 that generates dust, and other debris (hereafter, cuttings) while forming the borehole 11. During drilling operations, high-pressure gas, normally air, flows down a bore of the drill string 14 and exits at the drill bit 18. The gas returns via an annulus 20 and carries with it the cuttings and any produced liquids (collectively, ‘return material’) to the surface. At the surface, a flowline or “blooie” line 22 conveys the return material to a separator vessel 24. The separator 24 separates the return material into a gas stream (e.g., air) and a non-gas stream (e.g., dust, cuttings, foam, produced liquids, etc.) and discharges the non-gas stream into a suitable containment tank 26. It should be understood that the separation is not “perfect,” i.e., the non-gas stream may include some air and the gas stream may include some liquids and solids.

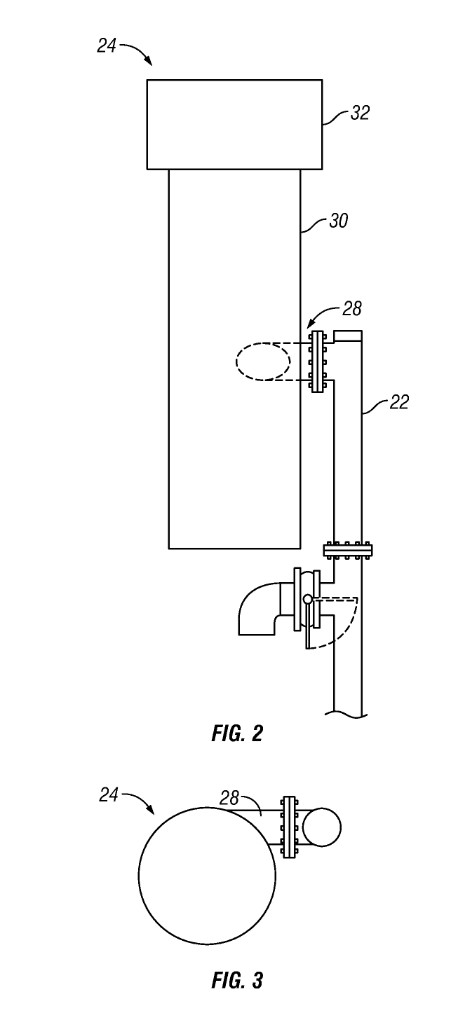

Referring now to FIGS. 1 and 2, there is shown one embodiment of a separator vessel 24 in accordance with the present disclosure. The vessel 24 receives the return material via the blooie line 22. The vessel 24 separates the drilling fluid (e.g., air) from entrained solids and liquids using a swirling-type action in conjunction with gravity. As best shown in FIG. 3, the swirling action occurs because the vessel 24 receives the return material via an inlet 28 that is oriented such that the return material enters the vessel 24 at a tangential angle. In one embodiment, the vessel 24 includes a chamber 30 and a cap 32, the details of which are discussed below.

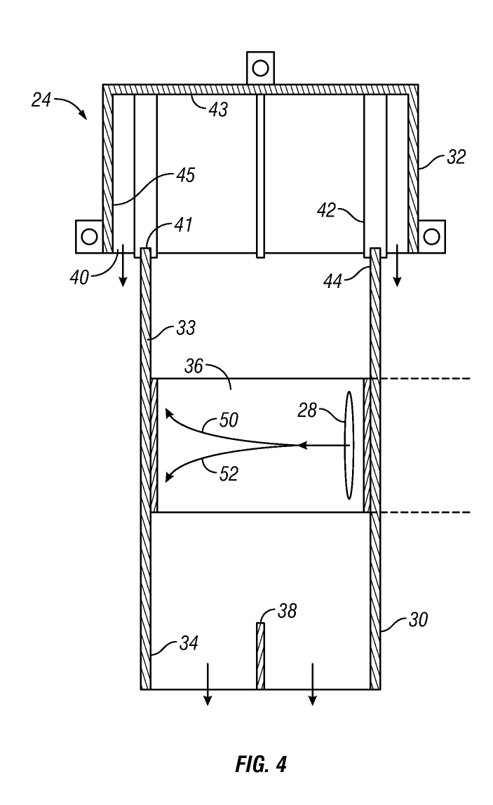

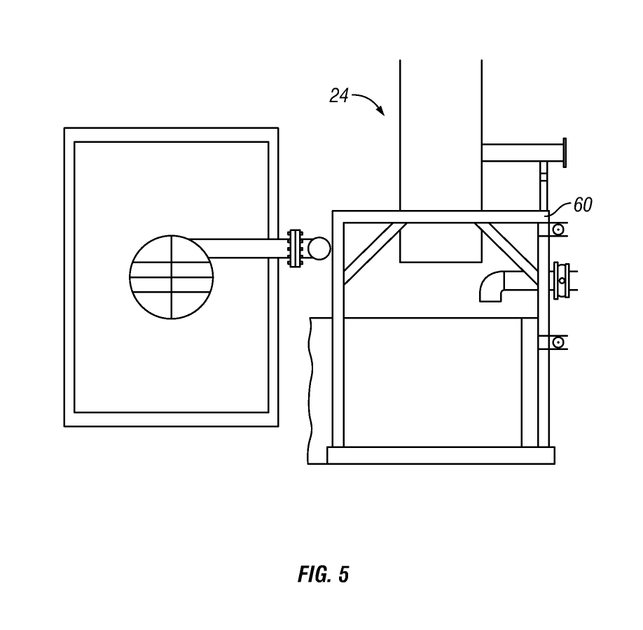

Referring now to FIGS. 2 and 4, in one embodiment, the chamber 30 may be a cylindrical or drum-like body that has an upper end 33 and a lower end 34, both of which are open. The inner surfaces of the chamber 30 may be protected against abrasion or corrosion due to the flowing return material. For example, a liner 36 made of hard ox or other similar relatively hard material may be affixed to the inner surfaces of the chamber 30. Additionally, a flow directing vertical plate 38 may be positioned within the chamber 30 near the lower end 34. While the inlet 28 is shown at a medial position along the chamber 30, it should be appreciated that the inlet 28 may be positioned at any suitable axial position as long as gravity is given enough time to pull the liquids and solids downward and out of the lower end 34. Additionally, it should be appreciated that a certain variance may be applied to the tangential entry of the return materials. That is, the entering return material should have an angle of entry that is substantial enough to induce a swirling action. Thus, as used herein, the term “tangent” refers to a general relationship that is inclusive of such variances. During use, the chamber 30 is oriented such that air may flow upward along the longitudinal axis of the chamber 30 and that non-gas components may flow downward along the longitudinal axis of the chamber 30.

Referring particularly to FIG. 4, there is sectionally shown the cap 32 in greater detail. The cap 32 may be a generally cylindrical body that has a diameter greater than that of the chamber 30. The cap 32 at least partially encloses the upper end 33 so that the gas stream does not vent vertically upward. An annular vent space 40 defined by the cap 32 and the chamber 30 allows the gas stream and portions of the non-gas materials (if present) to escape. The cap 32 may also include legs 42 that are configured to rest on a rim 44 of the chamber 30. The cap 32 may be secured to the chamber 30 by chains (not shown) in case of an unforeseen discharge of air or gas.

In one embodiment, the flow areas for the gas stream in the cap 32 are at least as large as the cross-sectional flow area in the chamber 30 in order to induce substantially more gas to flow primarily out of the vent space 40 as opposed to the lower end 34. For example, the gap or vertical distance between the top 41 of the chamber 30 and the top 43 of the cap 32 is selected to provide a circumferential flow area (e.g., roughly the surface area of a cylinder) at least as large as the cross sectional flow area of the chamber 30 (e.g., roughly the area of a circle). Likewise, the annular gap, which may also be referred to as an opening or vent, between the separator chamber 30 and the side wall 45 of the cap 32 also is at least the same as or exceeds the cross sectional flow area of the chamber 30. This minimizes the amount of air volume discharging out the lower end 34 along with the liquids and cuttings.

Referring now to FIGS. 1-4, during operation, a relatively high volume of air may be circulated into the wellbore (e.g., 4000 CFS). This circulated air, along with liquids and drill cuttings are conveyed by the blooie line 22 to the separator vessel 24. As these fluids and solids enter the chamber 30, their energy is immediately reduced by the inlet 28 being positioned at a tangent to the chamber 30. It should be noted that the wear resistant liner 36 inside the chamber 30 mitigates the erosion tendencies of the drill cuttings flowing along the interior surfaces of the chamber 30. Also, since the mixture of air, drill cuttings and liquids have entered the chamber 30 at a tangent, there is a spinning or swirling effect. It should be appreciated that the swirling effect is generated by the energy in the flow return material and not by adding energy in the vessel 24. That is, there are no mechanical spinning elements in the vessel 24 that force the return material to swirl. The return material separates into a gas stream 50 that flows vertically upwards and a non-gas stream 52 that falls vertically downward due to gravitational pull. As the swirling non-gas stream reaches the bottom of the chamber 30, the vertical cross plate 38 stalls the swirl and allows the non-gas materials to drop straight down into the tank 26. Meanwhile, the cap 32 redirects the upward flowing gas stream downward to the vent 40. Thus, the gas stream exits the vessel 24 via the vent 40. Also, any remaining non-gas materials (e.g., stray foam or liquids) drip out the vent 40 into the tank 26 or other suitable containment device located below the separation vessel. It should be appreciated that the flow area for the gas stream is maintained at least as large as a flow area through which the non-gas stream flows. This may be the flow area of the non-gas stream that acts that most influences the upward flow of the gas stream, which may or may not be the smallest flow area associated with the non-gas stream flow.

Referring now to FIG. 5, there is shown a stand 60 that may be used to support the separator vessel 24. The stand may be purpose-built for the separator vessel 24. The stand may be sized so that the tank 26 may be positioned below the separator vessel 24. For ease of transportation, the stand may have a height of 8 feet. Hand rails may be included to facilitate work by personnel.

While a tank has been shown as receiving the separated liquids and solids, it should be understood that other systems may be used to handle these separated materials. For example, a slide or other similar conveyance device may be positioned below the separator vessel. Such a conveyance device may readily transport the separated materials to a drying shaker. The shaker may then separate the liquid for recycling. Also, this system may also incorporate a drying shaker for immediate separation of solids from the liquids that are expelled from the separator vessel 24.

While the foregoing disclosure is directed to the preferred embodiments of the disclosure, various modifications will be apparent to those skilled in the art. It is intended that all variations within the scope of the appended claims be embraced by the foregoing disclosure.

What is claimed is:

1. An apparatus for separating a return material generated while drilling a borehole into a gas stream and a non-gas stream, comprising:
a chamber having an open upper end and an open lower end, the chamber oriented to allow gravity to pull the non-gas stream through the lower end;
an inlet associated with the chamber, the inlet oriented to flow the return material into the chamber at a tangent; and
a cap partially enclosing the upper end and defines a vent for venting the gas stream.

2. The apparatus of claim 1 wherein the vent has a cross-sectional flow area at least as large as a cross sectional flow area of the chamber.

3. The apparatus of claim 1 wherein a diameter of the cap is greater than the diameter of the chamber.

4. The apparatus of claim 1 wherein a surface area of a top of the cap minus a cross sectional flow area of the chamber is at least equal to the cross sectional flow area of the chamber.

5. The apparatus of claim 1, wherein a gap separating an upper end of the chamber and a transverse inner surface of the cap defines a flow area least equal to a cross sectional area of the chamber.

6. The apparatus of claim 1, further comprising a liner disposed on an interior surface of the chamber, the liner being of a harder material than the material of the chamber.

7. The apparatus of claim 1, further comprising a longitudinal plate positioned at the lower end, the plate being oriented to cause a substantially axial flow along the chamber.

8. The apparatus of claim 1, wherein the opening and the lower end are each configured to direct a portion of the non-gas stream into a receiving container.

9. A method for separating a return material generated while drilling a borehole into a gas stream and a non-gas stream, comprising:
flowing the return material at a tangent into a chamber having an open upper end and an open lower end, the chamber oriented to allow gravity to pull the non-gas stream through the lower end;
flowing the gas stream to the open upper end;
directing the gas stream to a vent using a cap partially enclosing the upper end; and
flowing the non-gas stream to the open lower end using primarily gravity.

10. The method of claim 9, further comprising maintaining a flow area for the gas stream that is at least as large as a flow area through which the non-gas stream flows.

11. The method of claim 9, wherein a surface area of a top of the cap minus a cross sectional flow area of the chamber is at least equal to the cross sectional flow area of the chamber.

12. The method of claim 9, wherein a gap separating an upper end of the chamber and a transverse inner surface of the cap defines a flow area least equal to a cross sectional area of the chamber.

13. The method of claim 9, further comprising at least partially lining an interior surface of the chamber with a material harder material than the material of the chamber.

14. The method of claim 9, further comprising causing a substantially axial flow along the chamber using a longitudinal plate positioned at the lower end.

15. The method of claim 9, further comprising directing a portion of the non-gas stream into a receiving container using the vent and the chamber lower end.
